(19) United States
(12) Patent Application Publication
(10) Pub. No.: US 2005/0236989 A1
(43) Pub. Date: Oct. 27, 2005

(54) Plasma display panel

(76) Inventor: Takeru Okada, Yamanashi-ken (JP)

Correspondence Address: ARENT FOX PLLC, 1050 CONNECTICUT AVENUE, N.W., SUITE 400, WASHINGTON, DC, 20036, US

(21) Appl. No.: 11/091,709

(22) Filed: Mar. 29, 2005

(30) Foreign Application Priority Data
Mar. 29, 2004 (JP) 2004-96280

(51) Int. Cl. H01J 17/49

(52) U.S. Cl. 313/582

(57) ABSTRACT

A discharge space is formed between a front glass substrate and a back glass substrate which are placed opposite to each other and a discharge is caused in the discharge space. The discharge space is filled with a discharge gas including 0.0001% to 1.0% by volume of hydrogen gas.

### BACKGROUND OF THE INVENTION

1. Field of the Invention

This invention relates to a structure of plasma display panels.

The present application claims priority from Japanese Application No. 2004-96280, the disclosure of which is incorporated herein by reference.

2. Description of the Related Art

In a plasma display panel (hereinafter referred to as “PDP”), typically, a reset discharge is caused between paired row electrodes. Then, an address discharge is caused selectively between one of the paired row electrodes and a column electrode. Thereupon, light-emitting cells having the deposition of wall charge on a dielectric layer adjoining the discharge cell and light-extinguishing cells in which the wall charge has been erased from the face of the dielectric layer are distributed over the panel surface. After that, a sustaining discharge is caused between the paired row electrodes in each light-emitting cell. By means of this sustaining discharge, vacuum ultraviolet light is emitted from xenon included in the discharge gas filling the discharge space. By the vacuum ultraviolet light, phosphor layers of the primary colors, red, green and blue, are excited to emit visible color light, thereby forming the image on the panel surface.

A gas mixture of neon (Ne) and xenon (Xe) is typically used as the discharge gas filling the discharge space of such a PDP.

The relationship between the discharge-starting voltage and the light-emitting efficiency of the PDP is a so-called “tradeoff”, in which, if the concentration of xenon (Xe) in the discharge gas is increased, the light-emitting efficiency can be enhanced because of an increase in the quantity of vacuum ultraviolet light emitted by the sustaining discharge, but the discharge probability is reduced because of a rise in the discharge voltage in each discharge as described above.

A high concentration of xenon (Xe) in the discharge gas gives rise to the problems of prolonging the time period required for aging in the manufacturing process for PDPs, and of speeding up the degradation of blue phosphor (BAM) forming the blue phosphor layer.

Conventionally suggested PDPs use a discharge gas resulting from adding 0.1% or less oxygen (O₂) to a neon-xenon mixture to reduce the occurrence of a false discharge without reducing the light-emitting efficiency.

Such conventional PDPs are described, for example, in Japanese Patent Laid-open publication 11-120920.

However, this conventional PDP has still not solved the two problems of the impossibility of increasing the light-emitting efficiency and discharge probability without a drop in the discharge starting voltage of the PDP.

### SUMMARY OF THE INVENTION

An object of the present invention is to solve the problems associated with conventional plasma display panels as described above.

To attain this object, in an aspect of the present invention, a plasma display panel has two substrates placed opposite each other to form a discharge space between them. The discharge space is filled with a discharge gas for producing discharge in the discharge space. The discharge gas includes 0.0001% to 1.0% by volume of hydrogen gas.

To attain the above object, a plasma display panel according to another aspect of the present invention has two substrates placed opposite each other to form a discharge space between them. The discharge space is filled with a discharge gas for producing discharge. The discharge gas includes 0.001% to 0.1% by volume of hydrogen gas.

Accordingly, in a preferred embodiment of the present invention, a PDP has a discharge gas filling a discharge space formed between the two opposed substrates, and including 10% or more by volume of xenon and 0.0001% to 1.0% by volume, preferably 0.001% to 0.1% by volume, of hydrogen gas.

In a PDP so designed, because the discharge gas includes 0.0001% to 1.0% by volume, preferably 0.001% to 0.1% by volume of hydrogen gas, the discharge starting voltage for initiating discharge in the discharge space of the PDP drops and the light-emitting efficiency and the discharge probability increase.

These effects become particularly noticeable when the concentration of xenon in the discharge gas is high, e.g. 10% or more by volume.

With a PDP having the discharge space filled with a discharge gas including 0.0001% to 1.0% by volume, preferably 0.001% to 0.1% by volume, of hydrogen gas, only a short aging time in the manufacturing process is required for achieving the stabilization of the discharge starting voltage and the discharge delay.

Further, hydrogen gas is included in the discharge gas, thereby inhibiting the degradation of blue phosphor (BAM) forming a blue phosphor layer.

These and other objects and features of the present invention will become more apparent from the following detailed description with reference to the accompanying drawings.

### BRIEF DESCRIPTION OF THE DRAWINGS

FIG. 1 is a front view illustrating an embodiment of a PDP according to the present invention.

FIG. 2 is a sectional view taken along the V-V line in FIG. 1.

FIG. 3 is a sectional view taken along the W-W line in FIG. 1.

FIG. 4 is a graph showing the change in discharge voltage relative to the hydrogen-gas concentration in the discharge gas.

FIG. 5 is a graph showing the change in light-emitting efficiency relative to the hydrogen-gas concentration in the discharge gas.

FIG. 6 is a graph showing the change in discharge delay relative to the hydrogen-gas concentration in the discharge gas.

FIG. 7 is a graph showing the change in discharge starting voltage relative to the aging time.

FIG. 8 is a graph showing the change in discharge delay relative to the aging time.

### DETAILED DESCRIPTION OF THE PREFERRED EMBODIMENT

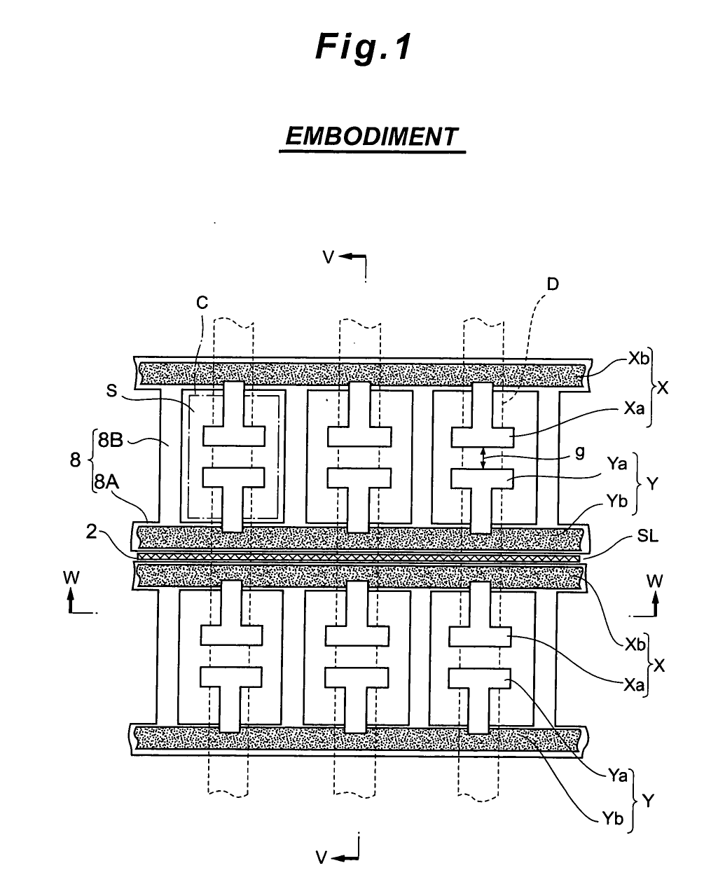

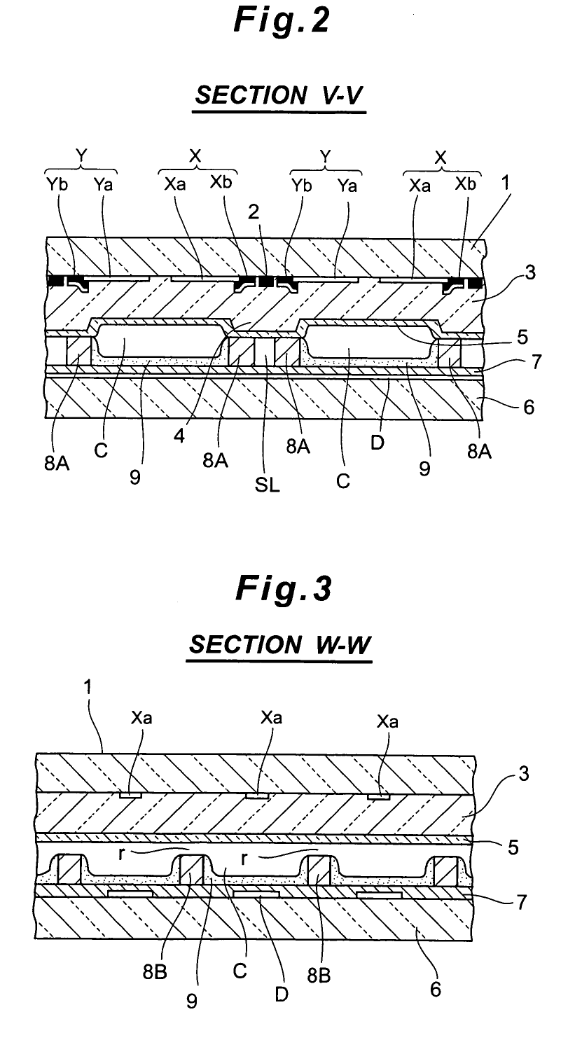

FIGS. 1 to 3 illustrate an embodiment of a PDP according to the present invention. FIG. 1 is a schematic front view of the PDP in the embodiment. FIG. 2 is a sectional view taken along the V-V line in FIG. 1. FIG. 3 is a sectional view taken along the W-W line in FIG. 1.

The PDP in FIGS. 1 to 3 has a plurality of row electrode pairs (X, Y) extending in a row direction of a front glass substrate 1 (the right-left direction in FIG. 1) and arranged in parallel on the rear-facing face of the front glass substrate 1 serving as the display surface.

A row electrode X is composed of T-shaped transparent electrodes Xa formed of a transparent conductive film made of ITO or the like, and a bus electrode Xb formed of a metal film. The bus electrode Xb extends in the row direction of the front glass substrate 1. The narrow proximal end (corresponding to the foot of the “T”) of each transparent electrode Xa is connected to the bus electrode Xb.

Likewise, a row electrode Y is composed of T-shaped transparent electrodes Ya formed of a transparent conductive film made of ITO or the like, and a bus electrode Yb formed of a metal film. The bus electrode Yb extends in the row direction of the front glass substrate 1. The narrow proximal end of each transparent electrode Ya is connected to the bus electrode Yb.

The row electrodes X and Y are arranged in alternate positions in a column direction of the front glass substrate 1 (the vertical direction in FIG. 1). In each row electrode pair (X, Y), the transparent electrodes Xa and Ya are regularly spaced along the associated bus electrodes Xb and Yb and each extend out toward its counterpart in the row electrode pair, so that the wide distal ends (corresponding to the head of the “T”) of the transparent electrodes Xa and Ya face each other with a discharge gap g having a required width in between.

Black- or dark-colored light absorption layers (light-shield layers) 2 are further formed on the rear-facing face of the front glass substrate 1. Each of the light absorption layers 2 extends in the row direction along and between the back-to-back bus electrodes Xb and Yb of the row electrode pairs (X, Y) adjacent to each other in the column direction.

A dielectric layer 3 is formed on the rear-facing face of the front glass substrate 1 so as to cover the row electrode pairs (X, Y), and has additional dielectric layers 4 projecting from the rear-facing face thereof toward the rear of the PDP. Each of the additional dielectric layers 4 extends in parallel to the back-to-back bus electrodes Xb, Yb of the adjacent row electrode pairs (X, Y) in a position opposite to the bus electrodes Xb, Yb and the area between the bus electrodes Xb, Yb.

A protective layer 5 made of magnesium oxide (MgO) is formed on the rear-facing faces of the dielectric layer 3 and the additional dielectric layers 4.

The front glass substrate 1 is parallel to a back glass substrate 6 on both sides of a discharge space S. Column electrodes D are arranged in parallel at predetermined intervals on the front-facing face of the back glass substrate 6. Each of the column electrodes D extends in a direction at right angles to the row electrode pair (X, Y) (i.e. the column direction) in a position opposite to the paired transparent electrodes Xa and Ya of each row electrode pair (X, Y).

On the front-facing face of the back glass substrate 6, a white column-electrode protective layer (dielectric layer) 7 covers the column electrodes D and in turn partition wall units 8 are formed on the column-electrode protective layer 7.

Each of the partition wall units 8 is formed in a substantial ladder shape of a pair of transverse walls 8A and vertical walls 8B. The transverse walls 8A each extend in the row direction in the respective positions opposite to the bus electrodes Xb and Yb of each row electrode pair (X, Y). The vertical walls 8B each extend in the column direction between the pair of transverse walls 8 in a mid-position between the adjacent column electrodes D. The partition wall units 8 are regularly arranged in the column direction in such a manner as to form an interstice SL extending in the row direction between the back-to-back transverse walls 8A of the adjacent partition wall sets 8.

The ladder-shaped partition wall units 8 partition the discharge space S between the front glass substrate 1 and the back glass substrate 6 into quadrangles to form discharge cells C in positions each corresponding to the paired transparent electrodes Xa and Ya of each row electrode pair (X, Y).

In each discharge cell C, a phosphor layer 9 covers five faces: the side faces of the transverse walls 8A and the vertical walls 8B of the partition wall unit 8 and the face of the column-electrode protective layer 7. The three primary colors, red, green and blue, are individually applied to the phosphor layers 9 such that the red, green and blue discharge cells C are arranged in order in the row direction.

A portion of the protective layer 5 covering the surface of the additional dielectric layer 4 is in contact with the front-facing face of the transverse wall 8A of the partition wall unit 8 (see FIG. 2), to thereby block off the discharge cell C and the interstice SL from each other. However, a clearance r is formed between the front-facing face of the vertical wall 8B and the protective layer 5, so that the adjacent discharge cells C in the row direction communicate with each other by means of the clearance r.

A discharge gas fills the discharge space S defined between the front glass substrate 1 and the back glass substrate 6. The discharge gas includes 10 percent by volume or more of xenon, and has gas components as described later.

In a PDP so designed, a reset discharge, an address discharge and a sustaining discharge are caused in the discharge cell C to form an image.

More specifically, in the reset period, the reset discharge is concurrently caused between the paired transparent electrodes Xa and Ya of all the row electrode pairs (X, Y). The reset discharge results in the complete erasure of the wall charge from a portion of the dielectric layer 3 adjoining each discharge cell C (or the deposition of wall charge on the same portion). Then, in the address period, the address discharge is caused selectively between the transparent electrode Ya of the row electrode Y and the column electrode D. Thereupon, the light-emitting cells having the deposition of wall charge on the dielectric layer 3 and the light-extinguishing cells in which the wall charge has been erased from the face of the dielectric layer 3 are distributed over the panel surface in accordance with an image to be displayed. In the following sustaining discharge period, the sustaining discharge is caused between the paired row electrodes Xa and Ya of the row electrode pair (X, Y) in each light-emitting cell.

By means of this sustaining discharge, vacuum ultraviolet light is emitted from the xenon included in discharge gas. By the vacuum ultraviolet light, the phosphor layers 9 of the primary colors, red, green and blue, are excited to emit visible color light, thereby forming the image on the panel surface.

In the operation of the PDP designed in this manner, the relationship between the discharge-starting voltage and the light-emitting efficiency of the PDP is the so-called “tradeoff”. As described earlier, by increasing the concentration of xenon (Xe) in the discharge gas, the light-emitting efficiency can be enhanced. However, the discharge starting voltage increases, resulting in a reduction of the discharge probability.

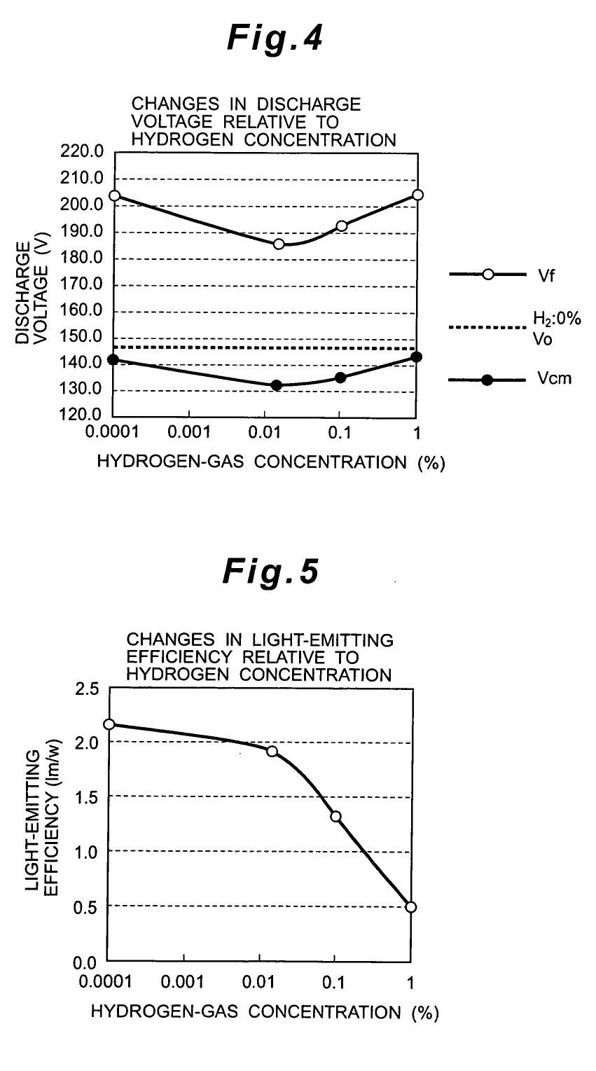

For the purpose of overcoming the two problems of how to increase the light-emitting efficiency and discharge probability and reduce the discharge-starting voltage without an increase in the concentration of xenon (Xe) in the discharge gas, various experiments has been conducted to investigate the effects of the inclusion of various gases in the discharge gas filling the discharge space of the PDP, on the discharge characteristics. Among these various experiments, FIGS. 4 to 8 are graphs showing the results of the experiment aimed at investigating the changes in discharge characteristics relative to the concentration of hydrogen gas.

FIG. 4 shows the change in discharge voltage relative to the hydrogen-gas concentration when hydrogen gas (H₂) is added to the discharge gas (a mixture of neon and 10% or more by volume of xenon), in which Vf denotes the discharge-starting voltage, Vsm denotes the minimum discharge-sustaining voltage, and the dotted line shows the minimum discharge sustaining voltage V₀ when the hydrogen-gas concentration in the discharge gas is zero percent.

It is seen from FIG. 4 that the discharge starting voltage Vf and the minimum discharge sustaining voltage Vsm both decreases to approximately a minimum value when the hydrogen-gas concentration in the discharge gas ranges from about 0.01% to about 0.1%.

FIG. 5 shows the change in light-emitting efficiency relative to the hydrogen-gas concentration when hydrogen gas (H₂) is added to the discharge gas (a mixture of neon and 10% or more by volume of xenon).

It can be seen from FIG. 5 that the light-emitting efficiency drastically drops when the hydrogen-gas concentration in the discharge gas is about 0.1% or more.

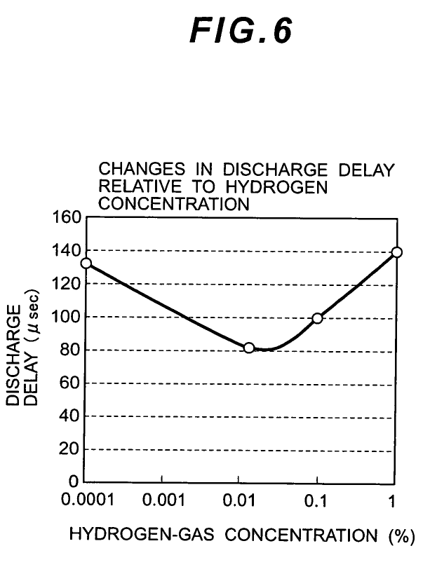

FIG. 6 shows the change in discharge delay relative to the hydrogen-gas concentration when hydrogen gas (H₂) is added to the discharge gas (a mixture of neon and 10% or more by volume of xenon).

It can be seen from FIG. 6 that the discharge delay decreases to approximately a minimum value when the hydrogen-gas concentration in the discharge gas ranges from about 0.01% to about 0.1%.

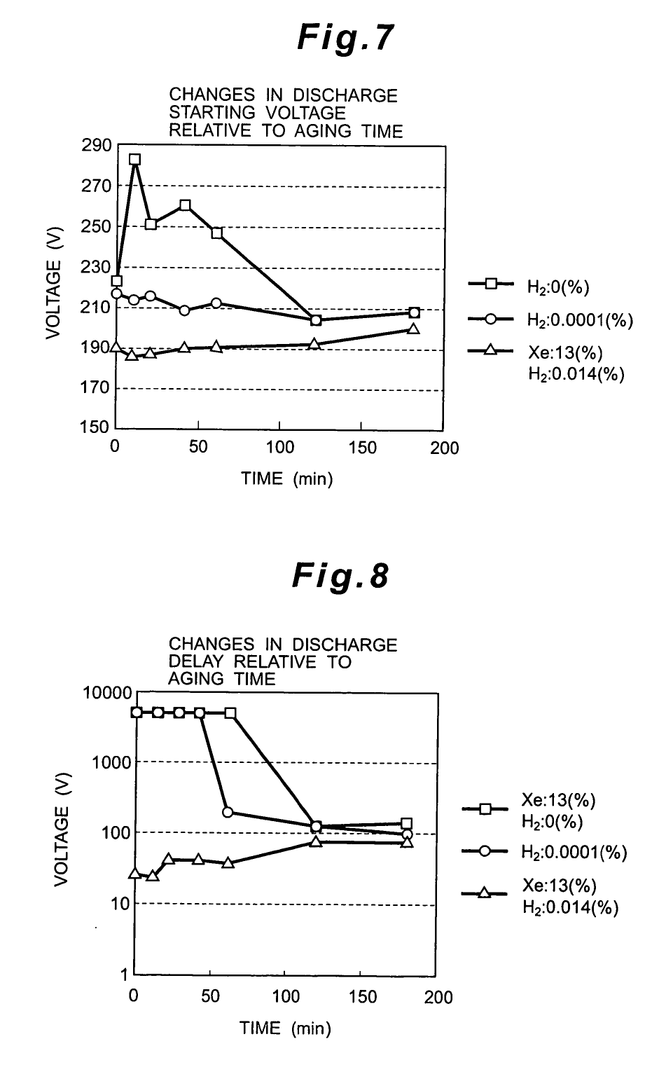

FIG. 7 shows the change in discharge-starting voltage relative to the aging time in the manufacturing process when hydrogen gas (H₂) is added to the discharge gas (a mixture of neon and 10% or more by volume of xenon) and the hydrogen-gas concentration is changed.

It can be seen from FIG. 7 that the stabilization of the discharge-starting voltage is achieved by a short aging time when the hydrogen-gas concentration in the discharge gas ranges from about 0.01% to about 0.1%.

FIG. 8 shows the change in discharge delay relative to the aging time in the manufacturing process when hydrogen gas (H₂) is added to the discharge gas (a mixture of neon and 10% or more by volume of xenon) and the hydrogen-gas concentration is changed.

It can be seen from FIG. 8 that the stabilization of the discharge delay is achieved by a short aging time when the hydrogen-gas concentration in the discharge gas ranges from about 0.01% to about 0.1%.

By this means, as is evident from the experimental results shown in FIGS. 4 to 6, the concentration of hydrogen gas in the discharge gas has a profound effect on the discharge characteristics of the PDP.

In these experiments, when the hydrogen-gas concentration in the discharge gas including 10% or more by volume of xenon is increased from 0.0001% byvolume (lppm), the discharge voltage drops, so that neither the light-emitting efficiency nor the discharge probability are drastically reduced.

However, when the hydrogen-gas concentration in the discharge gas is increased from approximately 0.01% by volume, the discharge voltage starts rising and the light-emitting efficiency and the discharge probability start to become drastically reduced.

Above all, when the hydrogen-gas concentration in the discharge gas exceeds about 0.1% by volume (1000 ppm), the reduction in the light-emitting efficiency becomes noticeable. When it exceeds 1.0% by volume (10000 ppm), the effect of the drop in discharge voltage is eliminated.

The effect of the hydrogen gas in the discharge gas on the discharge characteristics as described above is seen when the xenon concentration in the discharge gas is 10% or less by volume. The effect of the discharge voltage drop becomes noticeable when the xenon concentration in the discharge gas is 10% or more by volume.

The following are some conceivable reasons for this.

1. For example, in the PDP shown in FIGS. 1 to 3, when a discharge is produced in the discharge cell C, the hydrogen in the discharge gas is absorbed by the magnesium oxide (MgO) in the protective layer 5. This absorption causes positive charge to occur on the surface of the protective layer 5 and the work function in this area decreases. As a result, the xenon ions release secondary electrons, but normally this seldom occur. Due to this, the discharge voltage drops and the light-emitting efficiency and the discharge probability increase.

2. As is known, if oxygen deficiencies occur in the MgO forming the protective layer 5, when a discharge is produced in the discharge cell C, xenon ions also release Auger electrons and therefore the discharge voltage drops. For this reason, the hydrogen in the discharge gas passivates the oxygen deficiencies in the protective layer 5 to prevent an impurity gas from compensating for the oxygen deficiencies, resulting in a drop in the discharge voltage.

As is evident from FIGS. 7 and 8, when the discharge gas includes 0.0001% (1 ppm) or more by volume of hydrogen, the time required for the aging process is shortened in the manufacturing process for the PDP.

The effect of shortening the aging time becomes more and more noticeable with an increase in the hydrogen concentration, but does not change much when the hydrogen concentration exceeds a certain value.

This may possibly be because the activity of the hydrogen plasma is very strong and magnesium oxide (MgO) acts on hydrogen as a catalyst, so that organic impurities adhering to the surface of the protective layer 5 are dissolved in a short time.

Because the discharge gas includes 0.0001% (1 ppm) or more by volume of hydrogen gas, the advance of the degradation of blue phosphor (BAM) forming the blue phosphor layer 9 becomes slow.

A supposed cause of this is that adding hydrogen gas to the discharge gas inhibits the oxidation of Eu²⁺ serving as a core when the blue phosphor (BAM) emits light.

The terms and description used herein are set forth by way of illustration only and are not meant as limitations. Those skilled in the art will recognize that numerous variations are possible within the spirit and scope of the invention as defined in the following claims.

1. A plasma display panel having two substrates placed opposite each other to form a discharge space between them, comprising
a discharge gas filling the discharge space for producing a discharge in the discharge space and including 0.0001% to 1.0% by volume of hydrogen gas.

2. A plasma display panel according to claim 1, wherein the discharge gas includes 10% or more by volume of xenon.

3. A plasma display panel having two substrates placed opposite each other to form a discharge space between them, comprising a discharge gas filling in the discharge space for producing discharge in the discharge space and including 0.001% to 0.1% by volume of hydrogen gas.

4. A plasma display panel according to claim 3, wherein the discharge gas includes 10% or more by volume of xenon.
